(19) United States
(12) Patent Application Publication
(10) Pub. No.: US 2002/0021994 A1
(43) Pub. Date: Feb. 21, 2002

(54) Sulfur recovery gasification process for spent liquor at high temperature and high pressure

(76) Inventors: Jerry D. Blue, Jackson Township, OH (US); William Downs, Washington Township, OH (US); Timothy A. Fuller, Stark, OH (US); Christopher L. Verrill, Charleston, SC (US); Paul S. Weitzel, Lawrence Township, OH (US); Phung H. M. Chan, Calgary (CA)

Correspondence Address: McDermott Incorporated, Patent Department, Alliance Research Center, 1562 Beeson Street, Alliance, OH, 44601-2196, US

(21) Appl. No.: 09/945,927

(22) Filed: Sep. 4, 2001

Related U.S. Application Data
(63) Continuation of application No. 09/284,973, filed on Oct. 8, 1999.

(51) Int. Cl. D21C 11/00; B01D 45/00; B01D 47/00; C01B 17/16; C01B 31/20

(52) U.S. Cl. 423/224; 423/215.5; 422/185

(57) ABSTRACT

A method and apparatus for producing clean, sweet, fuel gas for use in a combustion process and for producing other useful products by processing a waste stream from digestion of lignocellulosic material. Essentially, the waste stream is partially oxidized to form hot gases and molten salts. The hot gases and molten salts are then cooled using a quench liquor to form quenched gas and carbonate liquor. Particles are removed from the quenched gas to form a raw fuel gas, preferably by subjecting the quenched gas to a multi-step fume reduction process which includes heat extraction from the quenched gas to reduce particulate load and water content of the quenched gas to form a low fume fuel gas. H₂S is removed from the low fume fuel gas using an H₂S removal process which is more selective for H₂S than it is for CO₂, the removing step forming clean, sweet, fuel gas and acid gases. The clean, sweet, fuel gas may be conveyed to a combustion process, advantageously a gas turbine/electric generator couple and possibly to a heat recovery steam generator, and/or it may undergo further processing to form other useful products. Likewise, the acid gases can be processed to form additional useful products. The optional multi-step fume reduction process passes the quenched fuel gas through a first venturi scrubber, an electrostatic agglomerator, and a second venturi scrubber in series.

### CROSS-REFERENCE TO RELATED APPLICATIONS

Reference is made to related U.S. Pat. No. 6,238,459 to William Downs (also a named co-inventor in the present application), issued May 29, 2001. U.S. Pat. No. 6,238,459 is hereby incorporated by reference as though fully set forth herein. Unless otherwise stated, definitions of terms in that patent are also valid for this disclosure.

This Continuation Application bases its priority from co-pending U.S. Ser. No. 09/284,973, filed on Apr. 23, 1999 and titled “Gasification Process for Spent Liquor at High Temperature and High Pressure.” To the extent that the parent application previously incorporated by reference now-abandoned U.S. Ser. No. 09/284,533 filed by Jerry D. Blue, William Downs, Timothy A. Fuller, and Christopher L. Verrill on Apr. 23, 1999, and titled “Sulfur Recovery From Spent Liquor Gasification Process,” the text of the U.S. Ser. No. 09/284,533 application is now explicitly included the text of this Continuation Application.

### FIELD AND BACKGROUND OF THE INVENTION

The present invention relates in general to pulp and paper spent chemical recovery processes, and in particular to a new and useful spent liquor gasification process, such as a black liquor gasification process, which provides a more efficient utilization of the spent chemical's fuel value in the production of electric power and which allows for the recovery of sulfur and other useful products from such spent liquor.

There is a large body of prior art relating to the removal and/or recovery of H₂S from petroleum and natural gas processes and from pulp and paper spent liquor chemical recovery processes. The motivation for removing H₂S from petroleum and natural gas processes is singularly to improve the quality of the product. Usually, these processes convert the H₂S to solid elemental sulfur because it facilitates storage and transportation. Most sulfur thus produced is ultimately converted to sulfuric acid at the point of use. In a few instances, H₂S is converted to sulfuric acid directly.

Prior art for H₂S recovery in the pulp and paper industry varies according to the specifics of the process. U.S. Pat. No. 3,323,858 deals with the absorption of H₂S with carbonate liquor. The carbonate liquor is then causticized to caustic liquor. U.S. Pat. No. 4,297,330 uses hot potassium carbonate to produce an acid gas stream containing H₂S, CO₂ and H₂O. The selectivity of that process for H₂S recovery over CO₂ recovery is only about 12 to 1. By comparison, as set forth in the DESCRIPTION OF THE PREFERRED EMBODIMENTS of the present invention, the selectivity of H₂S recovery over CO₂ recovery according to the present invention must be typically better than 100 to 1. Furthermore, the process described in U.S. Pat. No. 4,297,330 is not capable of achieving that degree of selectivity.

U.S. Pat. No. 4,609,388 describes a process that separates all of the components of a fuel gas into separate pure component streams. This process requires the complete dehydration of the fuel gas. This fact alone makes this process inappropriate for a spent liquor gasification process.

U.S. Pat. No. 5,205,908 deals directly with the issue of absorbing H₂S from a fuel gas generated by gasification of spent liquor. It is quite specific in stating that the absorption of H₂S is done with an alkaline wash solution that is not green liquor and has a composition where the mole ratio OH⁻/HS⁻ is greater than 8. This patent does not deal at all with the issue of the co-absorption of CO₂ and therefore is missing primary elements for its practical application.

U.S. Pat. No. 5,556,605 uses carbonate liquor to absorb both H₂S and CO₂ followed by steam stripping out the H₂S and using it outside the kraft pulping process in a process such as the Neutral Sulfite Semi-Chemical (NSSC) pulping process.

U.S. Pat. No. 5,660,685 deals with spent liquor gasification in such a way that H₂S is removed from the fuel gas and then returned to the gasifier so that the carbonate liquor produced by dissolving the molten salts from the gasifier has a very high sulfidity, and little carbonate. In the extreme, this approach has the possible advantage of eliminating the causticizing step. Although this idea has certain appeal, it has some significantly difficult steps; e.g., a Claus Reactor, H₂S compression and re-injection, and would be very difficult to implement.

A schematic representation of a conventional kraft recovery process is depicted in FIG. 1. This process consists of several unit operations. The key ones are the combustion of black liquor in a process recovery boiler 10, the conversion of green liquor to white liquor in a slaker/causticizer 12, the production of steam 14 for both process use and electric power production, and the calcination of calcium carbonate to lime (calcium oxide) in a lime kiln 16.

Gases from the recovery boiler 10 are passed to a dust collection apparatus 18, such as an electrostatic precipitator (ESP), and yield flue gas at 20 which can be released to a stack (not shown). Salt cake is returned at 22 to the inlet of recovery boiler 10 where it is mixed with incoming black liquor and combusted with air. Smelt at 24 from boiler 10 is passed to a dissolving tank 26 where it is contacted with weak wash 28. Dissolving tank 26 discharges green liquor 30 for input into the slaker/causticizer 12. White liquor 32 from the slaker/causticizer 12 is supplied to a digester (not shown) while reburned lime at 34 from kiln 16 is provided into the slaker/causticizer 12 where it reacts with sodium carbonate to produce the white liquor and solid calcium carbonate 36. The white liquor and solid calcium carbonate 36 are separated on a filter, 38, into a filter cake called lime mud 40 and the filtrate, i.e. the white liquor. The lime mud is washed with water, and the filtrate from the washing step is called weak wash 28. The lime mud 40 is provided to the kiln 16 which discharges flue gas 42 to a kiln stack (not shown).

This is a very mature process with few improvements over the past 40 years.

Although no fill scale, high pressure, high temperature, oxygen blown black liquor gasification (BLG) processes have been built to date, process concepts have been published. A generic process is depicted in FIG. 2. FIG. 2 illustrates one of the principal advantages of black liquor gasification over the conventional kraft recovery process, i.e., a substantial improvement in cycle efficiency through the use of combined cycle technology in the form of a gas turbine/steam turbine couple 50. In FIG. 2 and the remaining figures, the same reference numerals will be used to designate the same, or functionally similar parts.

One of the consequences of BLG is that a substantial portion of the sulfur in the black liquor is partitioned to the gas phase when compared to the conventional kraft process. In an H₂S scrubber 58 of the system depicted in FIG. 2, sulfur in the form of H₂S is reabsorbed into a mixture 52 of weak wash 28 and white liquor 56. CO₂ will also absorb into this solution. In fact, most of the free hydroxide in the mixture 52 of weak wash 28 and white liquor 56 will be consumed by the CO₂. It is therefore necessary to recycle an effluent 54 from the H₂S scrubber 58 back through the causticizing plant 12 (via the quencher 26) as shown in FIG. 2. This has the undesirable effect of increasing the burden on the causticizing plant 12 and lime kiln 16 by as much as 50% and results in a very large thermal penalty to the black liquor gasification process.

The black liquor gasification process can also generate a significant quantity of sub-micron sized alkali fume and soot. Alkali fume is extremely damaging to gas turbine blades. For this reason, it is vitally important that alkali fume and soot be controlled to a significant extent, perhaps to a removal efficiency as high as 99.9997% (five nines control). The conventional BLG process purports to do adequate control of fine particulate in a single venturi scrubber 60. However, the energy required to achieve adequate fume control in the single venturi scrubber 60 again places a significant energy penalty on the BLG process.

### SUMMARY OF THE INVENTION

The approach of the present invention to H₂S recovery and reuse differs significantly from the prior art.

An object of the present invention is to provide a method and apparatus for processing a waste stream from digestion of lignocellulosic material to form useful products, comprising: partially oxidizing the waste stream to form hot gases and molten salts; cooling the hot gases and molten salts using a quench liquor to form quenched gas and carbonate liquor; removing particles from the quenched gas to form a raw fuel gas; removing H₂S from the raw fuel gas using an H₂S removal process which is more selective for H₂S than it is for CO₂, the removing step forming usable fuel gas as one useful product, and acid gases; and

further processing the acid gases to form additional useful products.

Another object of the present invention is to provide a method and apparatus for producing clean, sweet, fuel gas for use in a combustion process by processing a waste stream from digestion of lignocellulosic material. This aspect of the invention requires removing particles from the quenched gas to form a raw fuel gas by subjecting the quenched gas to a multi-step fume reduction process which includes heat extraction from the quenched gas to reduce particulate load and water content of the quenched gas to form a low fume fuel gas. H₂S is removed from the low fume fuel gas using an H₂S removal process which is more selective for H₂S than it is for CO₂, the removing step forming clean, sweet, fuel gas and acid gases. Finally, the clean, sweet, fuel gas is conveyed to a combustion process.

The various features of novelty which characterize either embodiment of the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a flow chart showing a prior art kraft recovery apparatus and method;

FIG. 2 is a flow chart showing a prior art black liquor gasification apparatus and method;

FIG. 3 is a flow chart showing the apparatus and method of the present invention;

FIG. 4 is a graph plotting carbonate content against the hydrogen sulfide-carbon dioxide ratio;

FIG. 5 is a flow chart showing a typical proprietary SELEXOL process used in accordance with the present invention;

FIG. 6 is a flow chart similar to FIG. 1, but showing a conventional process; and

FIG. 7 is a flow chart showing an alternative embodiment employing a plurality of absorption-stripping units connected in series;

FIG. 8 is a flow chart showing the apparatus and method of the present invention; and

FIG. 9 is a schematic diagram of a fume and soot collection system of the present invention.

### DESCRIPTION OF THE PREFERRED EMBODIMENT

It should be initially noted that, while the method and apparatus of the present invention will likely find first commercial application to the processing of black liquor produced in the well known kraft pulping and recovery process, the present invention is not limited to that particular type of pulping process. For example, the present invention can also be applied to process alkaline, acidic, or neutral sulfite spent liquors, as well as polysulfide spent liquors. As is known to those skilled in the art, the terms “black liquor” or “smelt” are commonly used in connection with the kraft pulping process, while sulfite spent liquors are commonly called “red” liquors and not “black”, and polysulfite pulping liquor is commonly called “orange” liquor and not “white” liquor. Accordingly, it will be understood that while the terms black liquor, smelt, green liquor, white liquor, lime mud, and weak wash have been employed in the Figures and in the following description of the preferred embodiment of the invention, persons skilled in the art will appreciate that the invention is not limited merely to the kraft pulping process. Corresponding broader terminology such as spent liquor, molten salts, carbonate liquor, caustic liquor, and calcium carbonate solids may be substituted, respectively, for those terms as applicable, together with the same term weak wash depending upon the particular type of pulping process that is involved. Such broader terminology has been employed in the claims appended to and forming a part of this specification. Similarly, the present invention employs the term “lignocellulosic” to encompass all of the various types of feed stocks which one might want to employ in a pulping process, to broadly include woody and non-woody plants, whether or not the kraft type pulping process or other types of pulping processes are employed. For further details of the various aspects of pulping processes used in the paper industry, the reader is referred to STEAM Its Generation and Use, 40^{th} Ed., Stultz and Kitto, Eds., © 1992 The Babcock & Wilcox Company, particularly to Chapter 26—Chemical and Heat Recovery in the Paper Industry, the text of which is hereby incorporated by reference as though fully set forth herein.

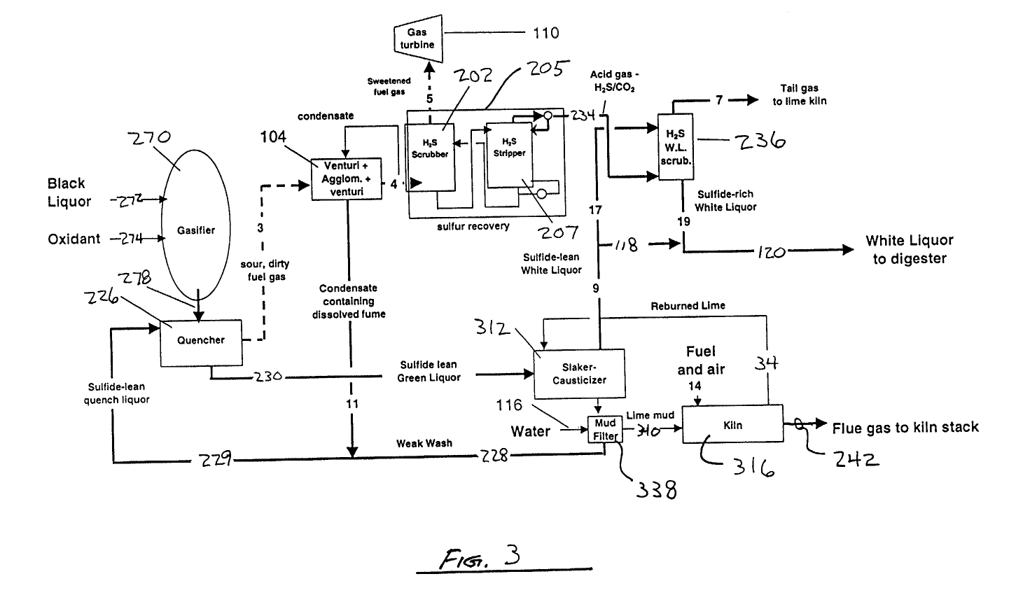

Referring to the drawings generally, wherein like reference numerals designate the same or functionally similar elements throughout the several drawings, and to FIG. 3 in particular, in its broadest form the process of the present invention begins with the atomization, partial combustion and gasification of a mixed organic/inorganic waste stream (Stream 272) resulting from the digestion of wood or other lignocellulosic materials. An oxidant (Stream 274) such as air or oxygen is used for the partial combustion.

This process takes place in suspension in a gasifier vessel 270 that is operated at above-atmospheric pressure, typically up to 800 psia, preferably between 300 and 600 psia. The hot fuel gases produced proceed to a quench zone 226 where a spray comprising process water and condensate (Stream 229), preferably a sulfide-lean quench liquor, rapidly cools the fuel gases. These quenched, sour, dirty fuel gases (Stream 3) will have sufficient heating value for use in a gas turbine, schematically indicated at 110. However, they will also contain alkali fume, carbonaceous aerosols, and reduced sulfur compounds that must be removed before the fuel gas can proceed to the gas turbine.

The particulate in the fuel gases will be predominantly sub-micron aerosol. The fuel gas first proceeds to a particulate removal stage 104 where up to 99.9999% (six nines control) of the alkali fume and carbonaceous aerosol are removed. Although this level of particulate removal is extreme, it is necessary to meet the very tight specification for alkali contamination of fuel gases entering the gas turbine 110. This particulate cleanup stage 104 will comprise a combination of one or more inertial-type dust collectors and may include an electrostatic dust collector/agglomerator to meet the most severe particulate requirements. For details of one such type of particulate removal equipment, reference is made to the aforementioned U.S. Pat. No. 6,238,459. Upon exiting from the particulate removal stage 104, the fuel gases (Stream 4) will then proceed to a system generally designated 205 for removal of H₂S from the fuel gas and which is designed for high selectivity of H₂S over CO₂. System 205 includes a process unit 202 designed to remove H₂S from the fuel gas, and preferably comprises an absorption step or H₂S scrubber and one or more stripping steps at 207. The fuel gases, after passing through the H₂S absorption step (Stream 5), will proceed into the gas turbine 110 or other suitable power generation equipment such as a steam generator. In the power generation equipment, any residual H₂S in the fuel gas will be oxidized to SO₂. SO₂ emissions resulting from the power generation step will be held below environmental emission limits by controlling the efficiency of the upstream H₂S removal system 205.

In the gasifier 270, where the organic portion of the waste was gasified by partial combustion and the water shift reaction, the inorganic alkali portion of this stream 278 will be liberated as a stream of molten salts. In the context of a kraft recovery process, the molten salt stream at 278 is referred to as smelt. This stream 278 consists principally of sodium carbonate and sodium sulfide. Much of the molten salts will impinge on the walls of the gasifier 270 and flow by gravity towards the quench zone 226. Some relatively coarse droplets of molten salts will remain suspended in the fuel gas, but both of these streams will be effectively captured in the quench zone 226. The fume and carbonaceous aerosol will not be efficiently captured in the quench zone 226 but will instead proceed along with the fuel gas and be collected by the particulate removal stage 104 described above. The molten salts produced by this high temperature, high-pressure gasification process will be lean in sodium sulfide when compared with those produced in a conventional Tomlinson boiler. The aqueous fluid stream 229 used for quenching the fuel gas will consist of condensate containing dissolved fume (Stream 11) and a weak alkaline process water stream commonly referred to in the industry as weak wash (Stream 228). This stream 228, in turn, comes from the washing with fresh water at 116 of the calcium carbonate precipitate (a.k.a. lime mud) that is created from a causticizing operation 312 to be described. The fluid used in the quencher 226 is thus a sulfide-lean quench liquor.

The sulfide-lean quench liquor 229, when combined in the quencher 226 with the molten salts at 278 from the gasifier 270, will form a solution of principally sodium carbonate, sodium disulfide and either sodium bicarbonate or sodium hydroxide. This solution is known in the kraft pulp and paper industry as green liquor or, more broadly, as carbonate liquor. Since the molten salts from which the carbonate liquor is formed are lean in sodium sulfide, so is the carbonate liquor (Stream 230), especially when compared to the carbonate liquor formed in the conventional kraft recovery process. This sulfide-lean carbonate liquor (Stream 230) is next taken to the causticizing plant 312 where the carbonate liquor first contacts powdered lime (Stream 34) in a conventional slaker-causticizer. The purpose of the slaker-causticizer 312 is to react slaked lime (calcium hydroxide) with aqueous sodium carbonate to form solid calcium carbonate and aqueous sodium hydroxide. A competing and undesirable reaction is between solid calcium hydroxide and aqueous sodium sulfide to form solid calcium sulfide and aqueous sodium hydroxide. Since the carbonate liquor (Stream 230) of the invention is lean in sodium sulfide, the causticizing is therefore more efficient when compared to a conventional kraft recovery process. Therefore, the amount of undesirable carbonate that stays with the caustic liquor (a.k.a. white liquor) (Stream 9) following the causticizer 312 will be less here than in a conventional process.

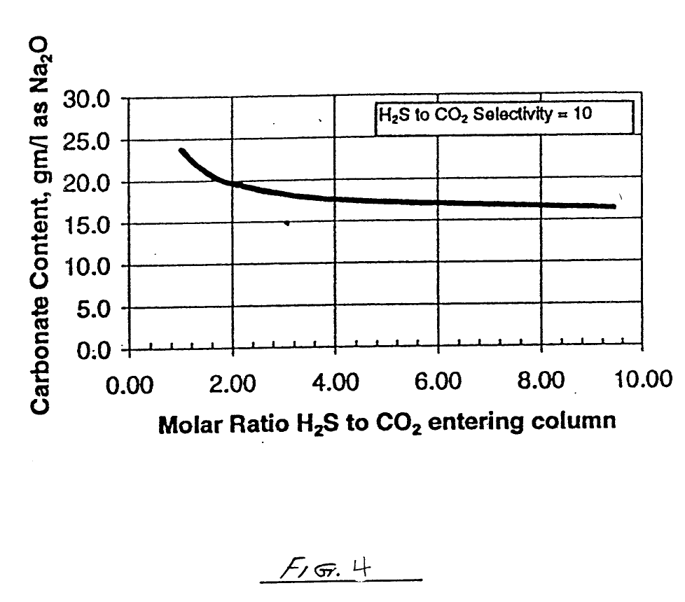

The caustic liquor (Stream 9) produced in this causticizer 312 is deficient in sulfide (i.e., sulfide-lean) when compared to conventional kraft recovery processes. For some pulping processes this would be a desirable trait. However, for the conventional kraft recovery processes, high sulfidity caustic liquor is preferred. Sulfidity is an industrial term, and is commonly defined as the molar ratio of HS⁻ to (HS⁻+OH⁻). To recover this sulfur value to the caustic liquor, it will be necessary to contact a portion of this caustic liquor (Stream 9) with the acid gases from the H₂S stripper 207 (Stream 234). In order to do this without overly carbonating the caustic liquor (Stream 9), it is necessary that the molar ratio of H₂S to CO₂ in Stream 234 coming from the H₂S stripper 207 be greater than about 2. The influence of the H₂S over CO₂ ratio on the caustic liquor (Stream 9) composition can best be illustrated with an example. If a tray type absorption column is used to scrub the H₂S and if the selectivity of H₂S over CO₂ is say 10, then an absorption column that is designed to remove 99% of the H₂S will remove approximately 37% of the CO₂ in that gas. In this example, it is assumed that the sulfide-lean caustic liquor (Stream 9) has a sulfidity of 12.3% and a carbonation extent of 13.7%. If that caustic liquor in Stream 17 contacts an acid gas (Stream 234) containing an H₂S to CO₂ ratio of 2.0 in an H₂S caustic liquor scrubber 236, then the sulfide-rich caustic liquor (Stream 19) leaving the H₂S contactor or scrubber 236 in this example would have a sulfidity of about 32.5% and a carbonation level of about 17.3%. The influence of the H₂S to CO₂ ratio entering the caustic liquor scrubber 236 on the caustic liquor composition leaving the scrubber is illustrated in FIG. 4. The amount of carbonation of the caustic liquor (Stream 19) will depend therefore on the ratio of H₂S to CO₂ in the acid gas (Stream 234) entering the caustic liquor scrubber 236. It also depends on the selectivity of that scrubber 236 to absorb H₂S in preference to CO₂. Any number of commercially available absorption columns can be used for the selective absorption of H₂S over CO₂. The caustic liquor, (sulfide-rich white liquor-Stream 19) upon leaving the scrubber 236, is suitable for use as pulping liquor without any further treatment.

A typical fuel gas (Stream 4) composition entering the H₂S removal system 205 is depicted in Table 1.

TABLE 1

| COMPONENT | MOLE % |
|---|---|
| H₂O | 0.69 |
| H₂ | 34.48 |
| N₂ | 0.63 |
| Ar | 1.41 |
| CO | 31.65 |
| CO₂ | 26.79 |
| CH₄ | 2.03 |
| H₂S | 2.32 |

The ratio of H₂S to CO₂ in this example is 0.0866. Recall from above that the H₂S to CO₂ ratio needs to be about 2.0 or higher before contacting the caustic liquor (Stream 17).

The absorption-stripping operation therefore has two distinct functions. The first is to reduce the H₂S concentration of the fuel gas 110 sufficiently so that when combusted in the gas turbine 110 the SO₂ concentrations in the turbine exhaust will be environmentally acceptable. The second function is to produce an acid gas stream with an H₂S to CO₂ ratio of at least 2.0. This means that the H₂S selectivity over CO₂ must be very high. Selectivity in this context is defined as the ratio of mass transfer coefficients, e.g. K_{g}a_{H}_{₂}_{S}/K_{g}a_{CO}_{₂}. Using σ to represent this selectivity, it can be shown that the selectivity can be expressed in terms of transfer units, NTU where NTU can be approximated by:

NTU_{H}₂_{ₛ}_{S}=−1n(1-ε)_{H}_{₂}_{S}

Then,

$$σ = \frac{N T {U}_{{H}_{2} S}}{N T {U}_{{CO}_{2}}}$$

If in this example the H₂S concentration leaving the scrubber 202 must be lowered from 2.32% to 100 ppm, that will require a removal efficiency of ε=1-0.0001/0.0232=0.9957 or 99.57%. Conversely, the CO₂ removal efficiency must be exceedingly low. If the acid gas is to have a ratio of H₂S to CO₂ of 2, then no more than 2.32×0.9957/2 moles of CO₂ can be absorbed (about 1.16 moles CO₂). Therefore, the CO₂ removal efficiency must not exceed 1.16/26.79, or 4.33%. Then the required selectivity must be:

$$σ = \frac{- l n ( 1 - .9957 )}{- l n ( 1 - .0433 )} = 123.1$$

This selectivity of 123.1 is beyond the capability of conventional absorption-stripping processes known to the inventors. A conventional absorption-stripping process or system is meant to imply a single absorption tower coupled with a single stripper tower. Even sterically hindered tertiary amines are capable of H₂S to CO₂ selectivities of no better than about 30.

A system that is capable of achieving adequate selectivity is the SELEXOL process.

SELEXOL is a trademark of UOP Canada Inc., Toronto, Canada, for its process of scrubbing H₂S. This commercially available process incorporates the use of a physical solvent and therefore absorbs various acid gas compounds in proportion to their partial pressure. The SELEXOL solvent itself is proprietary. Solvent regeneration is by pressure letdown of rich solvent. The solvent can be regenerated without heat. However, to reduce treated gas contaminants to low concentration, the solvent can be regenerated by a stripping medium such as an inert gas, or regeneration can be enhanced by the application of heat. Additional information concerning the publicly available SELEXOL process can also be found in HYDROGEN PROCESSING, April 1998, page 123.

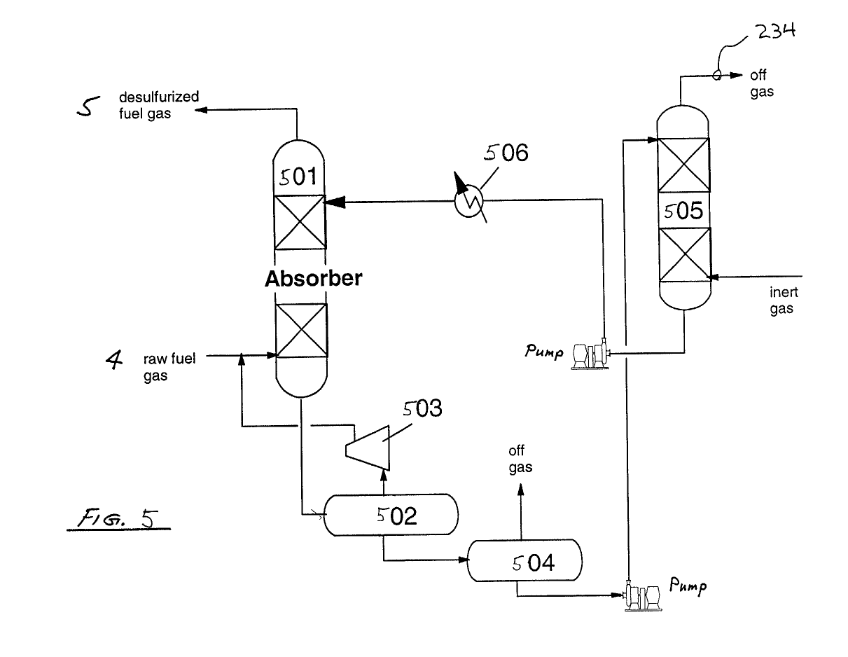

A generalized SELEXOL process flow diagram is depicted in FIG. 5. Feed gas enters an absorber 501 where contaminants are absorbed by the SELEXOL solvent. Rich solvent from the bottom then flows to a recycle flash drum 502 to separate and compress 503 any co-absorbed product gas back to the absorber. Further pressure reduction on the drum 504 releases off gases. In some applications, the solvent is regenerated in a stripper column 505. The regenerated solvent is then pumped through a cooler 506 and recycled back to the absorber 501.

The gases leaving the H₂S removal process such as the SELEXOL process are passed to a tower (236 in FIG. 3) where they are contacted with a portion of the sulfide lean caustic liquor (Stream 17) in FIG. 3. By proper design of this caustic liquor absorption tower 236, a selectivity of H₂S over CO₂ of about 10 to 15 is achievable. By designing this absorption tower to remove 99⁺% of the H₂S, the tail gases leaving this tower (Stream 7) can be taken directly to the lime kiln 316 for incineration or they can be delivered to the pulp mill□s non-condensible odor control system.

The SELEXOL solvent and process can be obtained from UOP Canada Inc. of Toronto Canada. There are SELEXOL processes which are available and which can be tailored to specific applications to enhance process performance. In the particular case of spent liquor gasification, the feed gas typically has a H₂S/CO₂ ratio which is less than 1:20. The requirement is for selective H₂S removal to less than 100 ppmv in the product gas while minimizing CO₂ co-absorption, such that the resulting acid gas to sulfur recovery has a H₂S/CO₂ ratio of at least about 1:1. See FIG. 4. In order to accomplish these goals effectively, the basic SELEXOL process is modified to a more specialized process illustrated in FIG. 5 that involves both selective absorption and selective desorption/regeneration.

The person having ordinary skill in this art can therefore practice the SELEXOL process, H₂S removal aspects of the present invention based on publicly available information.

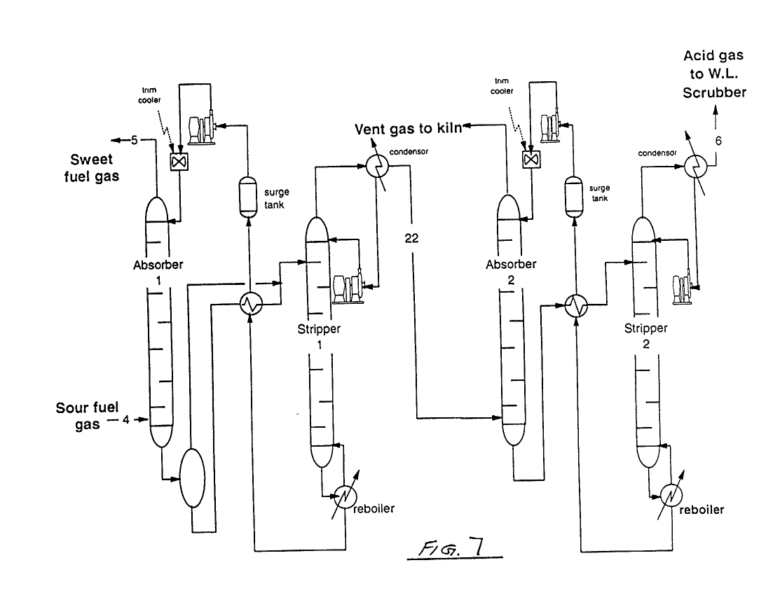

An alternate to the SELEXOL process which removes more H₂S than CO₂ is to subject the gases to a plurality of absorption-stripping units connected in series. For example, suppose that a conventional absorption-stripping system based on methyldiethanolamine (MDEA) were designed to contact the H₂S bearing fuel gas to achieve the desired level of H₂S control. If the fuel gas contained 1 part H₂S per 23 parts CO₂, the acid gas evolved from the stripper portion of the absorption-stripping unit could achieve a H₂S to CO₂ ratio of about 1 part H₂S to 1.8 parts CO₂. If this acid gas is now taken as the feed gas to a second absorption-stripping set, then the H₂S to CO₂ ratio achievable could be about 1.9:1. If a still higher ratio of H₂S to CO₂ is desired before contacting the acid gas with caustic liquor, as in tower 236 of FIG. 3, then a third absorption-stripping unit could be used. FIG. 7 illustrates one form of such a plurality of absorption-stripping units connected in series. As shown, stream 22 is the acid gas product from the first absorber-stripper set. Stream 22 becomes the feed to the second absorber-stripper set, whose output is the acid-gas stream 234 provided to the H₂S caustic liquor scrubber 236.

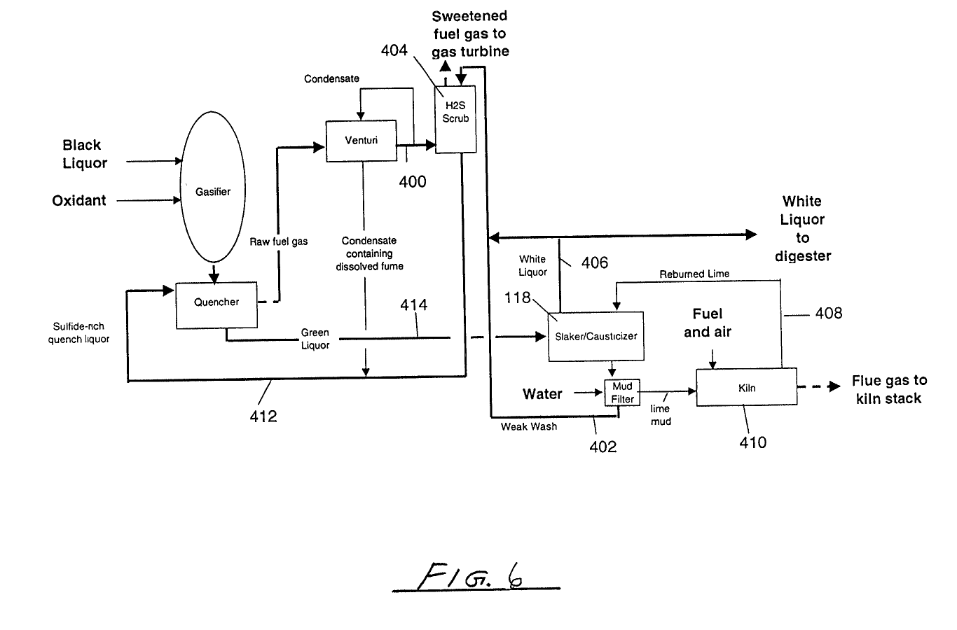

The principal improvement of the process of the invention is the ability of this gasification system to recover the H₂S from the fuel gas generated by gasifying spent liquor without increasing the burden on the causticizing system. The principal advantage has to do with savings in energy, i.e. fuel oil, that is required to calcine calcium carbonate that is produced in the causticizer. This advantage is derived by adding an intermediate step in the H₂S recovery system, i.e. the SELEXOL process or equivalent, that first creates an acid gas stream with a high H₂S to CO₂ concentration before contacting the acid gas with caustic liquor. A more conventional approach to H₂S recovery is depicted in FIG. 6. Here the fuel gas stream 400 is contacted directly with a mixture of weak wash 402 and caustic liquor 406 in a multistage tower 404. Because the CO₂ concentration is so much higher than the H₂S concentration, most of the caustic that was produced in the causticizer 312 is consumed by the absorption of CO₂. Therefore, that extra CO₂ must be recycled to the causticizer through the quencher via streams 412 and 414 and that CO₂ is therefore discharged through the lime kiln stack. Calcining of calcium carbonate is a highly energy intensive process and therefore creates a significant burden on the energy efficiency of this process. Moreover, many kraft pulp and paper mills have limited lime processing capacity in their rotary kilns 410. The additional amount of calcium carbonate that must be handled may require additional capital investment.

A second advantage of the present invention concerns the ability to produce both high sulfidity and low sulfidity caustic liquor. The portion of sulfide-lean caustic liquor used to recover sulfur from the acid gas becomes saturated with HS⁻ ion. This sulfide rich caustic liquor can be used advantageously to improve pulp properties by application to wood early in the kraft digestion process. It can alternately be blended with lean caustic liquor (Stream 118 in FIG. 3) to produce a conventional caustic liquor (Stream 120) of typical sulfidity and carbonate content.

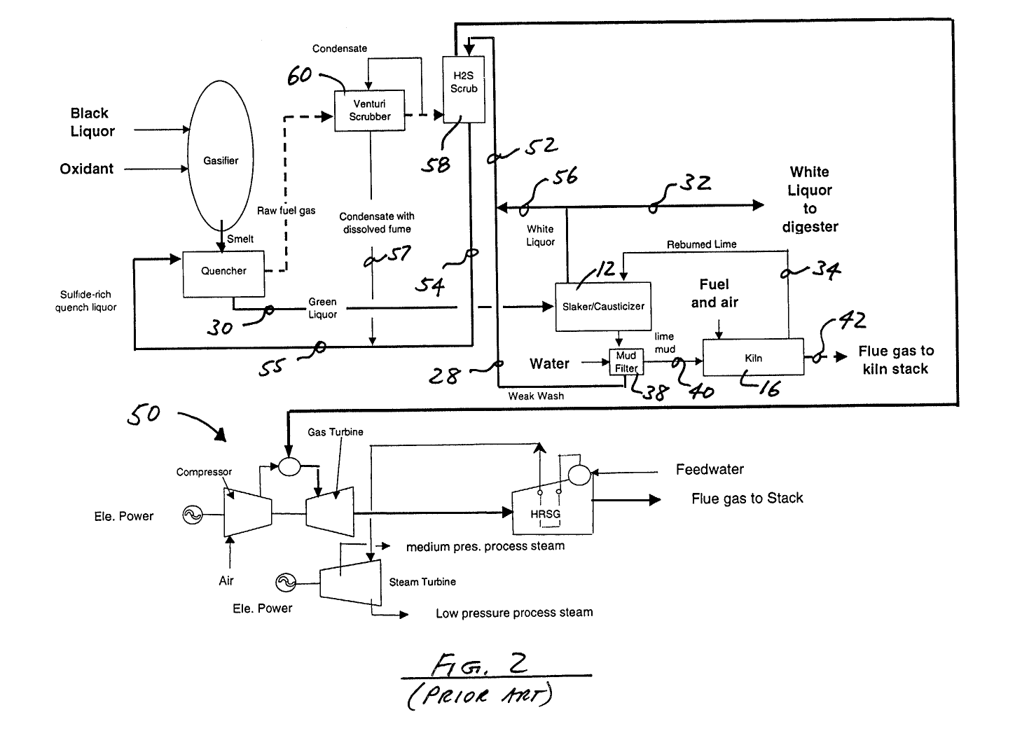

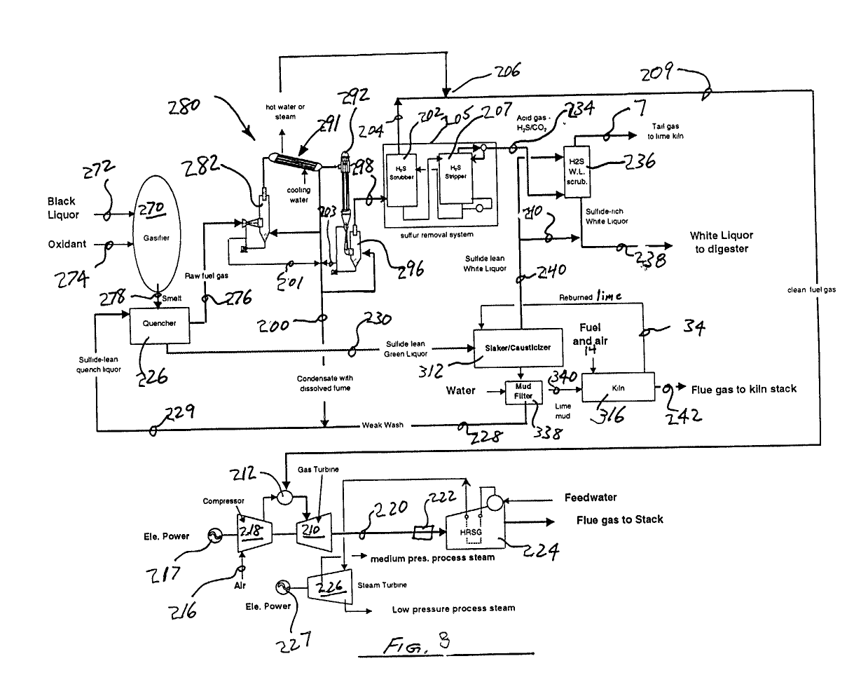

In FIG. 8, another process and apparatus contemplated by the present invention is shown. The apparatus includes several elements that are common to the generic BLG process depicted in FIG. 2. In its broadest form the process of the present invention begins with the atomization, partial combustion and gasification of a mixed organic/inorganic waste stream resulting from the digestion of wood or other lignocellulosic materials. An oxidant such as air or oxygen is used for the partial combustion.

A gasifier 270 of the invention is required, and preferably comprises a water jacketed, refractory lined vessel where a waste stream produced by the digestion of lignocellulosic materials, such as black liquor 272, typically containing less than 40% water is atomized and partially combusted with an oxidant 274, such as air or preferably oxygen or mixtures thereof. The gasifier 270 operates in a pressure range from atmospheric up to 800 psia, and preferably 300 to 600 psia. A stream 278 leaving the gasifier 270 will be in the temperature range of 1600 to 2200 F., typically about 1800 F. and comprises fuel gas 276 constituents, molten salts referred to in the pulp and paper industry as “smelt” (in a kraft recovery process), and a sub-micron sized mixture of alkali fume and soot. The molten smelt comprises relatively large molten droplets and/or streams which flow down the walls of the gasifier 270 towards a quencher 226. In the quencher 226, a relatively coarse spray comprising a mixture 229 of weak wash 228 (a slightly alkaline solution) and condensate with dissolved fume 200, is used to cool the fuel gas 276 to its adiabatic saturation temperature, which is typically in the range of about 300 to 400 F. While the evaporative cooling takes place in the quencher 226, the smelt constituents are collected quantitatively by the quench spray and dissolved therein. The resulting mixture 230 is sulfide lean and is known as green liquor. This stream 230 of green liquor will be subsequently causticized to white liquor in the slaker/causticizer 312. That portion of the process will be described in more detail later.

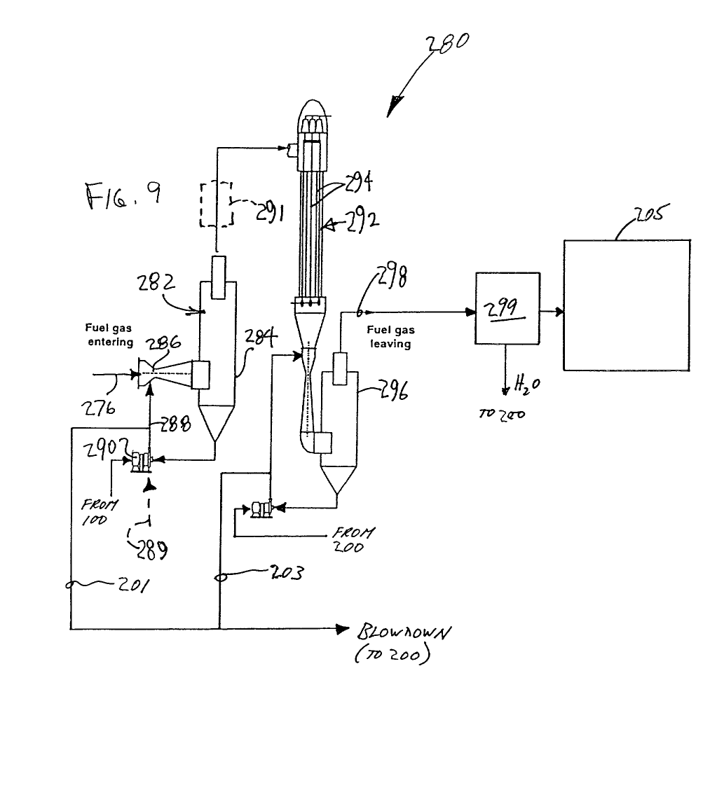

The raw fuel gas 276, upon leaving the gasifier quencher 226, will typically contain about 3500 ppm of H₂S, about 8% CO₂, a water content of over 1.75 lbs H₂O/lb dry gas, and a fume concentration as high as 800 grains per ft³ of fuel gas 76. To be an acceptable fuel gas for a gas turbine, the fume concentration in the fuel gas 276 must be reduced to less than about 0.0024 grains/ft³. To accomplish that feat, a three-step process 280 (shown in greater detail in FIG. 9) is employed according to the present invention.

Referring now to FIG. 9, in the three-step fume reduction process and apparatus 280, a first venturi scrubber 282 first contacts the fuel gas 276. The venturi scrubber 282 depicted in FIG. 9 will typically operate at a pressure drop of about 2 to 5 psi. Scrubber 282 uses a circulation of water 288 from a circulation pump 290, for example, through venturi 286 where the aqueous spray contacts the fuel gas 276 in the throat of the venturi 286. The water 288 may be taken from the quencher stream 100. The relatively high gas velocity (>200 ft/sec) and low liquid flow rate (<1 lb liquid/lb gas) promotes atomization of the liquid in the venturi throat and subsequent inertial impaction between the liquid droplets and the fume particles in venturi scrubber enclosure 284.

The purpose of this first venturi scrubber 282 is to reduce the dust loading of the fuel gas 276 to less than about 8 grains/ft³. Following this venturi scrubber 282 the fuel gas 276 is cooled (schematically indicated at 91 in FIG. 9) and the water content is reduced to less than about 0.35 lb H₂O/lb dry gas. Three separate approaches are available for this task. First, the fuel gas 276 can be cooled in a heat exchanger 291, advantageously a condensing heat exchanger, using cold, high-pressure process water from the mill or another source such as a cooling tower. After exiting the heat exchanger 291, the cooling water will be heated sufficiently for use in resaturating the fuel gas 276 after the H₂S removal operation (at 206) as described below. Thus, energy removed from the fuel gas 276 during the particulate control operations can be efficiently returned to the fuel gas later in the process. Alternatively, the fuel gas 276 can be cooled in the first venturi scrubber 282 by using cooled water from 289 as the aqueous spray 288. The heat absorbed by this water in the venturi scrubber 282 can be rejected by a liquid-to-liquid heat exchanger. The water condensed from the fuel gas 276 in this manner leaves the venturi 286 as blowdown 201. In a further alternative, the fuel gas 276 can be passed through a boiler 291 to generate steam for use within the paper making process. The reduction in water content of the fuel gas 276 from 1.75 to 0.35 lb H₂O/lb dry gas represents a greater than 50% reduction in total volumetric flow rate of fuel gas 276. Thus, the fuel gas treatment equipment to follow is greatly reduced in size.

The fuel gas 276 with the dust loading reduced to less than 8 grains/ft³ enters an electrostatic agglomerator-venturi scrubber arrangement depicted in FIG. 9. The electrostatic agglomerator (ESA) 292 is sized to collect at least 99.9% of the fume and soot not captured by the first venturi scrubber 282. The ESA 292 is designed to temporarily retain the collected material on the walls of its collection tubes 294 whereby it is re-entrained by the suitable use of rappers (not shown). A second venturi scrubber 296 subsequently captures the agglomerated solids. A source of water from quench stream 200, and a blowdown stream 203 may be employed as described above in connection with the first venturi scrubber 282. For details of one such type of particulate removal equipment 280, reference is made to the aforementioned U.S. Pat. No. 6,238,459.

Upon leaving the particulate control section 280, sour fuel gas 98 will contain about 7700 ppm H₂S and about 17% CO₂. The temperature will be about 325 F. This fuel gas 298 temperature is too hot to be effectively treated by conventional absorption-stripping processes for H₂S removal.

To accomplish adequate H₂S removal performance requires that the fuel gas 298 be cooled further. This cooling preferably takes place in another heat exchanger 299 again preferably a condensing heat exchanger, to cool the fuel gas stream 298. Leaving the heat exchanger 299, the fuel gas 298 water content has been lowered to about 0.01 lb H₂O/lb dry fuel gas. The H₂S concentration is raised to 10,900 ppm and the CO₂ concentration is 24.4%.

The water condensed from the fuel gas stream in the two heat exchangers 291, 299 (or alternate devices as described) and blowdown streams 201, 203 from the two venturi scrubbers 282, 296 are collected and sent to the quencher stream 200. The purpose of this aqueous stream is to control the concentration of salts in the green liquor 230. The pulp and paper mill requires that the green liquor salt concentration be within a specified range; typically 120-130 g/L as Na₂O. The water collected from the two venturi scrubbers and the heat exchangers is also contaminated with low levels of salts from the alkaline fume carryover. By taking this water back to the quencher 226, all alkali compounds are returned to the process.

The sour fuel gas 298 next enters an absorption column 202 (part of a sulfur removal system generally designated 205) where H₂S is preferentially absorbed from the fuel gas 298. The column 202 is designed to remove over 99% of the H₂S in the fuel gas. Some CO₂ is also removed from the fuel gas 298 in this absorption column. Chemical solvents such as methyldiethanolamine, MDEA, or a physical solvent such as the SELEXOL solvent can be used here.

The fuel gas 298 leaving the absorption column at 204 is next contacted with a stream of hot water and/or steam at 206. The hot water can come from the condensing heat exchanger 291 after the first venturi scrubber 282 as described earlier. The purpose is to produce reheated and humidified fuel gas 209 which is provided into a gas turbine 210. The fuel gas 209 is heated to a suitable temperature for the selected gas turbine. For example, for a General Electric Model 6FA gas turbine the fuel gas 209 is reheated to about 385 F., a water content of about 0.5 lb H₂O/lb dry fuel gas, and a pressure of about 300 psia. At the gas inlet of the turbine combustor 212 these gases are throttled before mixing with the combustion air in such a manner that the combustor 212 operates at about 50 psi below the fuel gas 209 inlet pressure. The gas turbine 210 is coupled to both an electric generator 217 and to a compressor 218 which supplies combustion air 216 to the combustor 212 at the operating pressure of the combustor 212. The system is flexible and can easily accommodate other gas turbine requirements.

The hot exhaust gases 220 leave the gas turbine 210 at a temperature above about 1000 F. These gases 220 contain in excess of 10% oxygen. Since these gases 220 are well above the auto-ignition temperature of natural gas, additional heat can be added to the turbine exhaust gases 220 by contacting these gases with natural gas in a duct burner 222. In this manner, the gases can be heated to above 1500 F. before entry into a waste heat boiler 224. This permits the generation of high pressure steam at, for example, 1250 psi and 925 F., but again other steam cycles can be used. This steam is suitable for use in a back pressure steam turbine 226 to produce electric power via electric generator 227, and also process steam.

The recovery and reuse of sulfur that began with the H₂S absorption column 202 described above is more particularly accomplished in the manner described here. The solvent used in the absorption step is transferred to a stripping column 207 where the pressure is reduced preferably to less than 30 psia. The solvent is then regenerated by heating. The combination of low pressure and high temperature causes the absorbed H₂S and CO₂ to evolve from the solvent into the gas phase. This unit operation is known as solvent regeneration. The gas 234 that evolves from the stripping column 207 is referred to as acid gas since it contains mostly H₂S and CO₂. The lean solvent leaving the stripping column is cooled and pumped to the pressure of the absorption column 202 for reuse. The cooling is accomplished by contacting the lean solvent with the rich solvent in a liquid-liquid heat exchanger or an air cooled heat exchanger.

The H₂S selectivity of the absorption-stripping process is critical. The ratio of H₂S to CO₂ in the raw, sour fuel gas 298 entering the absorption column will be on the order of 1 part H₂S to 20 parts CO₂ on a molar basis. The H₂S to CO₂ ratio in the acid gas leaving the steam stripper must be at least 1 part H₂S to 1 part CO₂. A ratio of 4 parts H₂S to 1 part CO₂ or higher is preferred. The SELEXOL process, available from UOP Canada Inc., Toronto, Canada, is one of the processes capable of this degree of H₂S selectivity. SELEXOL is a trademark of UOP Canada Inc. for its process and a solvent used in the process. The acid gases 234 are next contacted with sulfide lean white liquor 240 in an absorption column 236 designed to have a high selectivity for H₂S absorption over CO₂. In this manner, the sulfide can be returned to the pulping liquor stream as white liquor 238 without significant carbonation thereof. The white liquor 238 can in this manner be used directly in the pulping process without further chemical processing.

As described above, the production of pulping liquor for the digestion of wood chips begins (in the context of a black liquor gasification process) with the production of green liquor 230 in the quencher 226. Recall from above that the green liquor 230 was produced when the smelt constituents dissolved into the mixture 229 of weak wash 228 and condensate with dissolved fume 200 and recycle water during the quenching operation. The green liquor consists of a mixture of sodium carbonate, sodium hydroxide, and sodium sulfide. The weak wash 228 is produced when fresh water is used to wash white liquor from the filter cake of calcium carbonate that is produced in the causticizing operations at 312. This weak wash is shown as stream 228 in FIG. 8. From a chemical composition standpoint, the weak wash 228 can be thought of as dilute white liquor. The recycled water contains low levels of alkali compounds from the fume carryover. The recycled water is shown as stream 200 in FIG. 8. The calcium carbonate is produced as a suspended solid when green liquor contacts an aqueous suspension of calcium hydroxide in the causticizing plant 312. The solid calcium hydroxide reacts with the dissolved sodium carbonate to produce dissolved sodium hydroxide and solid calcium carbonate.

Soot (a sub-micron sized carbonaceous aerosol) that is caught by the venturi scrubbers 282 and 296 is removed from the aqueous phase at the mud filter 338 leaves the process by combustion in the lime kiln 316.

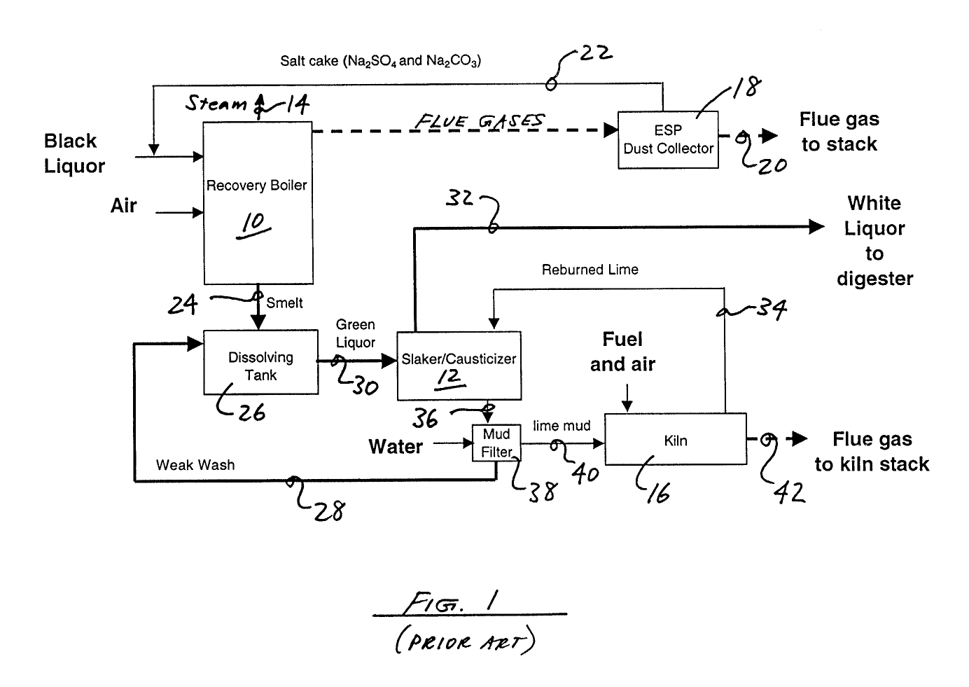

The green liquor stream 230 leaving the quencher 226 differs substantially from that of a conventional kraft recovery process as illustrated in FIG. 1. Green liquor stream 230 in FIG. 8 will contain as little as 50% of the sulfide of a conventional green liquor. That situation results from the much greater partition of sulfur as H₂S in the gas phase of the gasification process. This is one of the principal differences between black liquor gasification (BLG) and conventional kraft recovery. This difference provides the opportunity for several process improvements over conventional kraft recovery. First, the BLG scheme offers a causticizing improvement. One of the means by which sulfur is lost from the conventional kraft recovery process is through the precipitation of calcium sulfide (CaS). This precipitated CaS is separated along with the calcium carbonate (lime mud 340) on the vacuum filter 338 from the white liquor. This lime mud is then separated and taken to the rotary lime kiln 316 where any calcium sulfide co-mingled with the calcium carbonate is decomposed to CaO and SO_{2.} In the case of the present invention, since the green liquor is lean of sulfide, there is a proportionate reduction of calcium sulfide mixed with the lime mud sent to the kiln 316.

Another advantage of the low sulfidity green liquor in the BLG process is the fact that the white liquor produced from this green liquor will have a proportionately lower sulfidity. If all of this sulfide lean white liquor in stream 240 of FIG. 8 is used to contact the acid gas in stream 234, then by material balance constraints, the sulfidity of the white liquor in stream 238 would be equivalent to that of the conventional kraft recovery cycle. But, if only a portion of stream 240 contacts stream 234, then a white liquor stream with a higher sulfidity can be generated along with a stream of lower sulfidity white liquor. This offers the plant operator certain pulping options that are not available with the conventional kraft recovery process.

There are various advantages of the present invention. The Tomlinson recovery boiler is the current standard method and apparatus for chemical recovery in the kraft pulping process. Recovery boilers are costly, prone to corrosion and catastrophic smelt-water explosions and are limited to relatively modest steam temperatures and pressures. These limits constrain the-ability of this standard technology to effect improvements in electric power production. Black liquor gasification is widely viewed as the technology most likely to replace the recovery boiler.

If pressurized and coupled with gas turbines, BLG systems can provide more efficient utilization of black liquor fuel value and produce more electrical power relative to steam. This is an attractive feature for future mills where higher electrical usage will be required to operate mechanical pulping and pollution control equipment. Smelt-water explosions are a serious risk associated with recovery boilers and most BLG concepts eliminate the possibility of these catastrophic events. Unlike recovery boilers, BLG systems recover sodium and sulfur as separate streams which can be blended to produce a wide range of pulping liquor composition. This increased process flexibility of BLG may be a significant asset in future kraft pulping operations.

In addition to the general advantages of black liquor gasification, the specific embodiment of the present invention offers advantages that constitute improvements over other BLG systems. Other BLG processes can cause a significant burden on the causticizing plant, because of co-absorption of CO₂. This process avoids that problem by including the absorption-stripping process that greatly increases the ratio of H₂S to CO₂ in the gas that contacts the white liquor. This process provides means to eliminate alkali fume problems that could be a problem in other BLG processes. The inventors believe that the fume generation and control shown in other BLG process patents significantly understate the severity of this problem. The process and apparatus described in the present invention can realistically reduce fume and aerosol emissions below the gas turbine allowable limits.

The rapid quench of fuel gas from 1800 F. to about 400 F. by adiabatic humidification represents a significant portion of the chemical energy in the black liquor, or other type of waste stream. The means used to reclaim that energy into useful form is a challenge for any BLG process. The use of a heat exchanger or boiler to raise process steam between the first venturi 282 and the ESA 292 is an efficient way to recover nearly all of that waste heat as low-pressure (nominally about 80 psig) steam. This steam can be used as process steam throughout the pulp mill.

Within the framework of the apparatus and process described by FIG. 8, several alternatives are possible. All involve suspension gasification followed by a rapid quench to saturation with water. How the heat is recovered from the process is one area where several options exist. A condensing heat exchanger could be used to raise the temperature of high-pressure water from about 130 F. to about 340 F. This hot, high-pressure water can then be contacted with the fuel gas in a saturator as at 206. The excess water that is not evaporated into the fuel gas is cooled in a liquid-to-liquid heat exchanger, increased in pressure and sent back to the condensing heat exchanger thus forming a closed-loop system. In this embodiment, the heat that is not returned to the fuel gas in the form of water vapor is simply rejected from the system. In an alternate embodiment an economizer section from a boiler could be used in place of the condensing heat exchanger. Here, the fuel gas would generate low-pressure steam that could be used elsewhere in the paper plant.

The manner in which the fume and soot are collected in the process described in FIG. 9 is designed for the most severe range of particulate emissions likely to be encountered in black liquor gasification. If the dust loading from a particular gasifier were about two orders of magnitude below the estimate used for the design of this gasifier 270, then the first venturi scrubber 282 could be eliminated.

The process by which the H₂S is scrubbed from the fuel gas and delivered to the white liquor is subject to various possibilities. Although the SELEXOL process is the preferred means, other absorption-stripping processes are suitable for this gasification process. Sterically hindered tertiary amines such as methyldiethanolamine are one such compound that can be used in a conventional absorption-stripping process.

While a specific embodiment of the invention has been shown and described in detail to illustrate the application of the principles of the invention, it will be understood that the invention may be embodied otherwise without departing from such principles.

We claim:

1. A method for processing a waste stream from digestion of lignocellulosic material to form useful products, comprising:
partially oxidizing the waste stream to form hot gases and molten salts;
cooling the hot gases and molten salts using a quench liquor to form quenched gas and carbonate liquor;
removing particles from the quenched gas to form a raw fuel gas;
removing H₂S from the raw fuel gas using an H₂S removal process which is more selective for H₂S than it is for CO₂, the removing step forming a usable fuel gas and acid gases; and
further processing the acid gases to form additional useful products and without reusing the acid gases in any of the aforementioned steps.

2. The method according to claim 1, further comprising subjecting the carbonate liquor to a causticizer to form a caustic liquor and lime mud, the lime mud comprising a suspension of calcium carbonate, and further processing the acid gases by combining the caustic liquor with the acid gases in a caustic liquor scrubber to form a tail gas and a sulfur-rich caustic liquor.

3. The method according to claim 2, further comprising filtering the lime mud to separate the caustic liquor from the lime mud and washing the lime mud with water to produce weak wash.

4. The method according to claim 3, further comprising supplying the weak wash as part of the quenching liquor for cooling of the hot gases.

5. The method according to claim 4, further comprising forming a condensate with dissolved fumes while removing particles from the quenched gas, and combining the condensate with dissolved fumes and the weak wash to form the quench liquor.

6. The method according to claim 2, further comprising calcining the lime mud in a kiln to produce calcium oxide.

7. The method according to claim 6, further comprising recycling the calcium oxide from the kiln to the causticizer.

8. The method according to claim 1, further comprising the step of recovering sulfur from the raw fuel gas as the H₂S is removed from the raw fuel gas.

9. The method according to claim 1, further comprising processing a waste stream of black liquor.

10. The method according to claim 1, further comprising processing a waste stream of red liquor.

11. The method according to claim 1, further comprising processing a waste stream of one of alkaline, acidic, and neutral sulfite spent liquor.

12. The method according to claim 1, further comprising processing a waste stream of polysulfide spent liquor.

13. An apparatus for processing a waste stream from digestion of lignocellulosic material to form useful products, comprising:
gasifier means for partially oxidizing the waste stream to form hot gases and molten salts;
quenching means, fluidically connected to the gasifier means, for cooling the hot gases and molten salts using a quench liquor to form quenched gas and carbonate liquor;
particle removing means, fluidically connected to the quenching means, for removing particles from the quenched gas to form a raw fuel gas;
H₂S scrubbing means, fluidically connected to the particle removing means, for removing H₂S from the raw fuel gas using an H₂S removal process which is more selective for H₂S than it is for CO₂, the removing step forming usable fuel gas as one useful product, and acid gases; and
means for further processing the acid gases to form additional useful products, the means for further processing only being fluidically connected to the H₂S scrubbing means in a manner which permits extraction of the acid gases without reusing any of the acid gases in the quenching means.

14. The apparatus according to claim 13, further comprising means for providing the carbonate liquor to causticizer means to form a caustic liquor and lime mud, the lime mud comprising a suspension of calcium carbonate, said processing means including means for combining the caustic liquor with the acid gases in a caustic liquor scrubber to form a tail gas and a sulfur-rich caustic liquor.

15. The apparatus according to claim 14, further comprising means for filtering the lime mud to separate the caustic liquor from the lime mud and means for washing the lime mud with water to produce weak wash.

16. The apparatus according to claim 15, further comprising means for supplying the weak wash as part of the quenching liquor for cooling of the hot gases.

17. The apparatus according to claim 16, further comprising means for forming a condensate with dissolved fumes while removing particles from the quenched gas, and means for combining the condensate with dissolved fumes and the weak wash together to form the quench liquor.

18. The apparatus according to claim 14, further comprising means for calcining the lime mud in a kiln to produce calcium oxide.

19. The apparatus according to claim 18, further comprising means for recycling the calcium oxide from the kiln to the causticizer means.

20. The apparatus according to claim 13, further comprising means for recovering sulfur from the raw fuel gas as the H₂S is removed from the raw fuel gas.

21. The apparatus according to claim 13, wherein the waste stream comprises black liquor.

22. The apparatus according to claim 13, wherein the waste stream comprises red liquor.

23. The apparatus according to claim 13, wherein the waste stream comprises one of alkaline, acidic, and neutral sulfite spent liquor.

24. The apparatus according to claim 13, wherein the waste stream comprises polysulfide spent liquor.

25. A method according to claim 1, wherein the removing the particles from the quenched gas further comprises subjecting the quenched gas to a multi-step fume reduction process which includes heat extraction from the quenched gas to reduce particulate load and water content of the quenched gas to form a low fume fuel gas; and wherein the usable fuel gas from the removing H₂S from the low fume fuel gas using an H₂S removal process forms a clean, sweet, fuel gas which is conveyed to a combustion process.

26. The method according to claim 25, wherein the multi-step fume reduction process comprises passing the quenched fuel gas through a first venturi scrubber, an electrostastic agglomerator, and a second venturi scrubber in series.

27. The method according to claim 25, further comprising subjecting the carbonate liquor to a causticizer to form a caustic liquor and lime mud, the lime mud comprising a suspension of calcium carbonate, and further processing the acid gases by combining the caustic liquor with the acid gases in a caustic liquor scrubber to form a tail gas and a sulfur-rich caustic liquor.

28. The method according to claim 27, further comprising filtering the lime mud to separate the caustic liquor from the lime mud and washing the lime mud with water to produce weak wash.

29. The method according to claim 28, further comprising supplying the weak wash as part of the quench liquor for cooling of the hot gases.

30. The method according claim 29, further comprising forming a condensate with dissolved fumes in the multi-step fume reduction process while removing particles from the quenched gas, and combining the condensate with dissolved fumes and the weak wash to form the quench liquor.

31. The method according to claim 27, further comprising calcining the lime mud in a kiln to produce calcium oxide.

32. The method according to claim 31, further comprising recycling the calcium oxide from the kiln to the causticizer.

33. The method according to claim 25, further comprising the step of recovering sulfur from the low fume fuel gas.

34. The method according to claim 25, further comprising processing a waste stream of black liquor.

35. The method according to claim 25, further comprising processing a waste stream of red liquor.

36. The method according to claim 25, further comprising processing a waste stream of one of alkaline, acidic, and neutral sulfite spent liquor.

37. The method according to claim 25, further comprising processing a waste stream of polysulfide spent liquor.

38. The method according to claim 25, further comprising conveying the clean, sweet, fuel gas to a combustor of a gas turbine coupled to an electric generator.

39. The method according to claim 38, further comprising producing hot exhaust gases in the gas turbine and conveying the hot exhaust gases to a waste heat boiler and producing steam in the waste heat boiler.

40. The method according to claim 39, further comprising conveying steam from the waste heat boiler to a steam turbine coupled to an electric generator.

41. The method according to claim 1, further comprising contacting one of hot water and steam obtained from the quenched gas as it is processed in the multi-step fume reduction process with the clean, sweet, fuel gas to increase the heat and water content of the clean, sweet, fuel gas.

42. The apparatus according to claim 13, wherein the particle removing means comprises a multi-step fume reduction process means for removing particles from the quenched gas to form a raw fuel gas which includes means for extracting heat and water from the quenched gas to reduce particulate load and water content of the quenched gas to form a low fume fuel gas; and wherein the usable fuel gas is a clean, sweet, fuel gas; and further comprising means for conveying the clean, sweet, fuel gas to a combustion process.

43. The apparatus according to claim 42, wherein the multi-step fume reduction process means comprises a first venturi scrubber, an electrostastic agglomerator, and a second venturi scrubber in series.

44. The apparatus according to claim 42, further comprising means for providing the carbonate liquor to causticizer means to form a caustic liquor and lime mud, the lime mud comprising a suspension of calcium carbonate, said processing means including means for combining the caustic liquor with the acid gases in a caustic liquor scrubber to form a tail gas and a sulfur-rich caustic liquor.

45. The apparatus according to claim 44, further comprising means for filtering the lime mud to separate the caustic liquor from the lime mud and means for washing the lime mud with water to produce weak wash.

46. The apparatus according to claim 45, further comprising means for supplying the weak wash as part of the quench liquor for cooling of the hot gases.

47. The apparatus according to claim 46, further comprising means for forming a condensate with dissolved fumes in the multi-step fame reduction process while removing particles from the quenched gas, and means for combining the condensate with dissolved fumes and the weak wash together to form the quench liquor.

48. The apparatus according to claim 44, further comprising means for calcining the lime mud in a kiln to produce calcium oxide.

49. The apparatus according to claim 48, further comprising means for recycling the calcium oxide from the kiln to the causticizer means.

50. The apparatus according to claim 42, further comprising means for recovering sulfur from the low fume fuel gas.

51. The apparatus according to claim 42, wherein the waste stream comprises black liquor.

52. The apparatus according to claim 42, wherein the waste stream comprises red liquor.

53. The apparatus according to claim 42, wherein the waste stream comprises one of alkaline, acidic, and neutral sulfite spent liquor.

54. The apparatus according to claim 42, wherein the waste stream comprises polysulfide spent liquor.

55. The apparatus according to claim 42, further comprising means for conveying the clean, sweet, fuel gas to a combustor of a gas turbine coupled to an electric generator.

56. The apparatus according to claim 55, wherein the gas turbine produces hot exhaust gases and comprising means for conveying the hot exhaust gases to a waste heat boiler to produce steam in the waste heat boiler.

57. The apparatus according to claim 56, further comprising means for conveying steam from the waste heat boiler to a steam turbine coupled to an electric generator.

58. The apparatus according to claim 42, further comprising means for contacting one of hot water and steam obtained from the quenched gas as it is processed in the multi-step fume reduction process with the clean, sweet, fuel gas to increase the heat and water content of the clean, sweet, fuel gas.
